(19) United States
(12) Patent Application Publication
(10) Pub. No.: US 2006/0136287 A1
(43) Pub. Date: Jun. 22, 2006

(54) Method and apparatus for creating a list for marketing

(75) Inventors: Prashant Gupta, Rajasthan (IN); Kulo Rajasekaran, Hyderabad (IN); Sutirtha Saha, Hyderabad (IN); Rajesh Tibrewala, Hyderabad (IN); Niroop Kumar Singh, Hyderabad (IN); Rajiv Kumar, Hyderabad (IN); Harvinder Singh Sawhney, Hyderabad (IN)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/022,542

(22) Filed: Dec. 22, 2004

(51) Int. Cl. G06F 17/30

(52) U.S. Cl. 705/10

(57) ABSTRACT

The method may entail reviewing a source of entries wherein the source is stored electronically, selecting a subset of entries from the source of entries and storing the subset of entries as a list wherein the list comprises a first order object.

### BACKGROUND

Attempts have long been made to make salespeople more effective. One way is to provide electronic and computer based tools for salespeople to better maintain contacts. The result has been that a significant amount of data is available for users but making sense of this data has been a challenge. In addition, tools have been developed to better review the contacts and separate the contacts by desired characteristics, but the handling of the resulting contacts has been difficult.

### SUMMARY

A method and apparatus to create a reusable list and its use as a marketing tool for salespeople is disclosed. The method may entail reviewing a source of entries wherein the source is stored electronically, selecting a subset of entries from the source of entries and storing the subset of entries as a list wherein the list comprises a first order object. The method may also include allowing a user to re-use a list, reviewing an internal source as the source of entries, importing additional details about the entries from the internal source if the source is an internal source, reviewing an external source as the source of entries, allowing the list to be emailed, qualifying the list by selecting entries from the source that have a desired attribute, allowing the list to be modified and saved as a second list, allowing the list to be queried using an existing query, allowing the list to be queried using a new query, creating a second list that is a result of a query on a first list and creating a third list by merging a first list with a second list. The entries may include accounts, leads and contacts. A computer readable medium with computer executable instructions to perform the method is also disclosed as is a computing apparatus with a processing apparatus that is programmed to perform the method.

### DRAWINGS

FIG. 1 is a block diagram of a computing system that may operate in accordance with the claims;

FIG. 2 is an illustration of a flowchart of a method in accordance with the claims;

FIG. 3 is an illustration of list create display in accordance with the claims;

FIG. 4 is an illustration of a list member view display in accordance with the claims;

FIG. 5 is an illustration of an action display in accordance with the claims;

FIG. 6 is an illustration of an add members by query display in accordance with the claims;

FIG. 7 is an illustration of a list qualification display in accordance with the claims;

FIG. 8 is an illustration of a query result in accordance with the claims;

FIG. 9 is an illustration of an add members display in accordance with the claims;

FIG. 10 is an illustration of a remove members by query display in accordance with the claims;

FIG. 11 is an illustration of a query result in accordance with the claims;

FIG. 12 is an illustration of a delete members display in accordance with the claims;

FIG. 13 is an illustration of a confirm delete members display in accordance with the claims;

FIG. 14 is an illustration of a look up records display in accordance with the claims;

FIG. 15 is an illustration of a member source display in accordance with the claims; and

FIG. 16 is an illustration of an activities status report in accordance with the claims.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘_’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

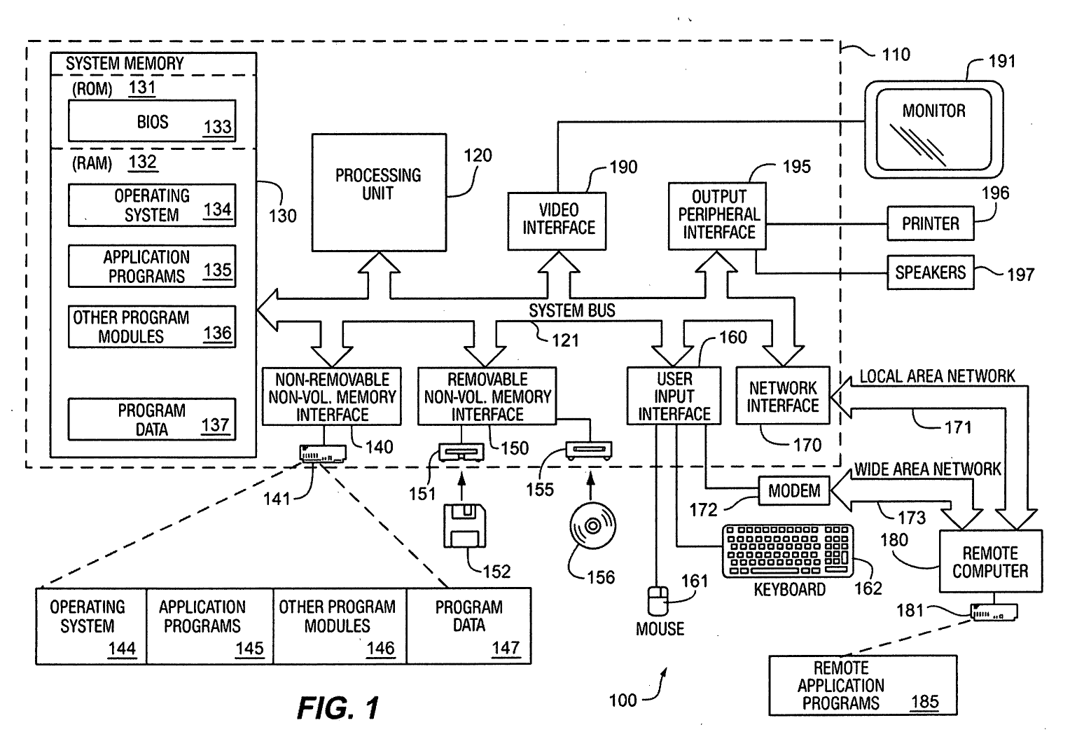

FIG. 1 illustrates an example of a suitable computing system environment 100 on which a system for the claimed method and apparatus may be implemented. The computing system environment 100 is only one example of a suitable computing environment and is not intended to suggest any limitation as to the scope of use or functionality of the method of apparatus of the claims. Neither should the computing environment 100 be interpreted as having any dependency or requirement relating to any one or combination of components illustrated in the exemplary operating environment 100.

The claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The claimed method and apparatus may be described in the general context of computer-executable instructions, such as program modules, being executed by a computer. Generally, program modules include routines, programs, objects, components, data structures, etc. that perform particular tasks or implement particular abstract data types. The methods and apparatus may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing an operation of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

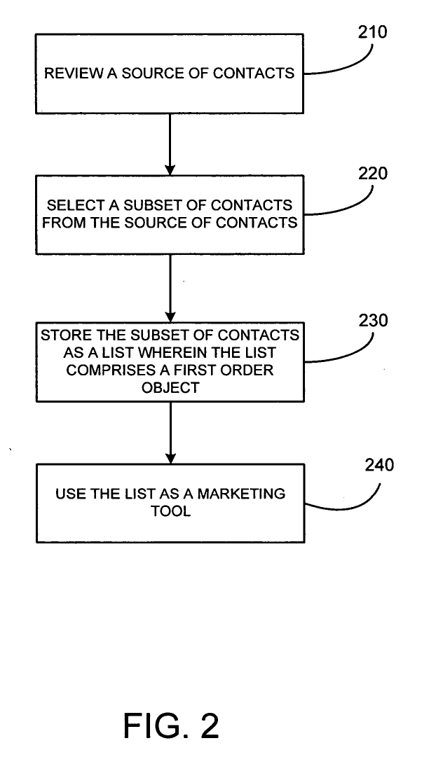

FIG. 2 may illustrate a method of creating a list for marketing. At block 210, a source of entries may be reviewed. The source of entries may come from a variety of places. For example, the source of entries may be an internal list from Microsoft Outlook, for example, or may be an external list that was purchased from an outside vendor. In addition, the entries may be contained in a CRM system already operated. The entries may be contacts, accounts and leads but in a broader sense, may be entities which a user may wish to contact and about which a user may wish to maintain some information. The entities are not just limited to people but may be organizations, corporations, governmental groups, etc.

At block 220, a subset of entries may be selected from the source of entries. The selection of the subset of entries may be based on a variety of factors. For example, a user could query the system to pull out all entries that have not placed an order within the last six months. The system would sort through the entries and pull out the entries that have not placed an order within the last six months. This subset of entries would then be selected. The may be a virtually limitless number of ways to query the source of entries.

At block 230, the method may store the subset of entries as a list wherein the list comprises a first order object. The list may be stored on any internal or external memory device. A first order object may be a language object that can be created dynamically, stored in a variable, passed as a parameter to a function, and returned as a result by a function. In addition, a first order object may have a unique, immutable identity within its scope in a distributed environment which may allow the object to be used for pointer navigation in a database and for maintenance of the referential integrity of the database without a lot of extra overhead. First order objects allow multiple unique objects with the same attribute values and first order objects always know what type they are. First order objects may be passed by arguments by reference. In addition, a first order object can be shared among multiple first class objects and if a first class object is changed, then the changes are visible to all other first class objects that refer to it. At block 240, the list may be used for marketing tool.

As a result of the list being a first order object, a user may be permitted to reuse the list. In addition, the list can easily be emailed as an attachment to an email. In addition, the list can be modified and saved as a second list.

Further, the list can be queried in a variety of ways. For example, the list can be queried using an existing query. As a further example, the query of searching for contacts that have not placed an order for at least six months could be run every month. The results of that query also may be stored as yet another list. Furthermore, a list can be queried using a new query. For example, a user could query a list and pull out all accounts that have not placed an order for at least three months. The results of a three month query may result in more contacts than the results of the six month query. In addition, a third list can be created by merging a first list with a second list.

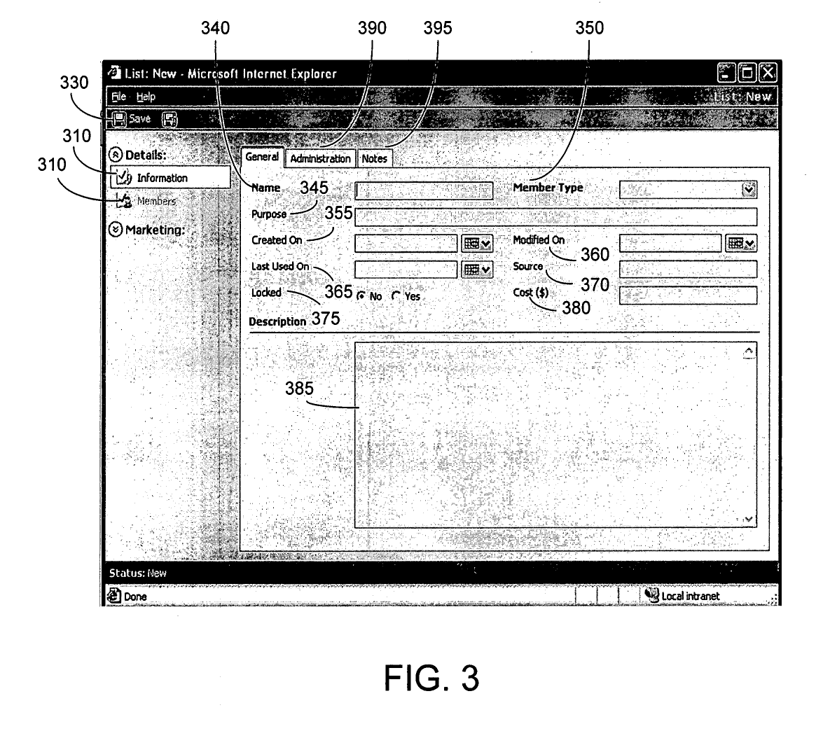

FIG. 3 may be an illustration of a sample display for creating a list. By selecting the option information 310, information on the list may be displayed. In addition, the user may select to see members of the list by selecting the members tab 320. In addition, the user may select to save the list by selecting the save tab 330. The list may be given a name 340, it's purpose may be saved as part of the list 345, member types may also be saved 350, as can the relevant dates such as when the list was created 355, when the list was modified 360, when the list was last used 365, what source was used to create the list 370, whether the list is locked 375, and any costs associated with the list 380. By locking the list, the list may be protected from being modified by any other users. In addition, a user may add further description 385 which may be useful to help sort out lists a future point in the future. In addition, a user may select an administration tab 390 in which a user may make changes related to administration of the list such as who has permission to see the list, who has permission to modify the list, who has permission to delete the list, etc. In addition, a user can select notes 395 to add further notes to the selected list.

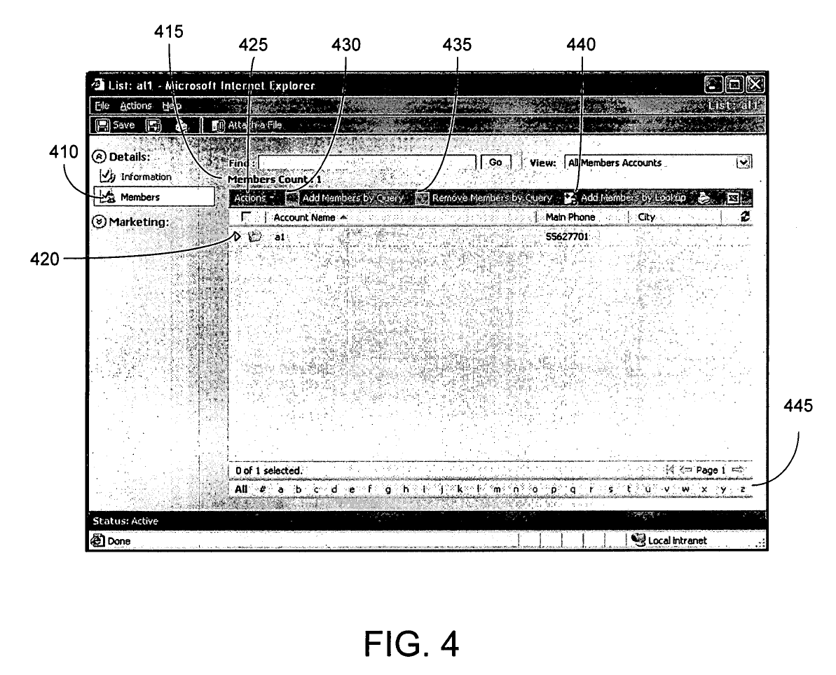

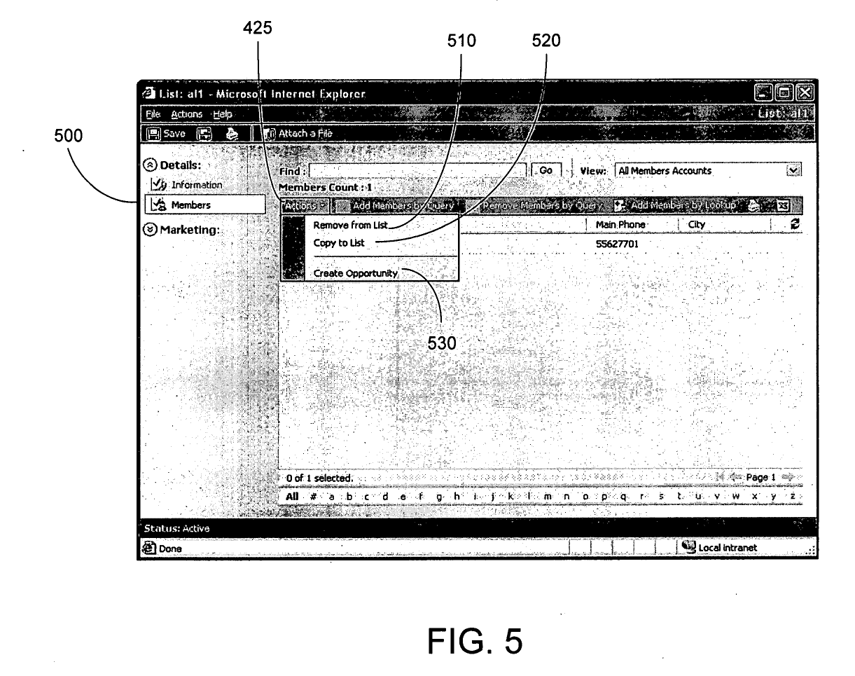

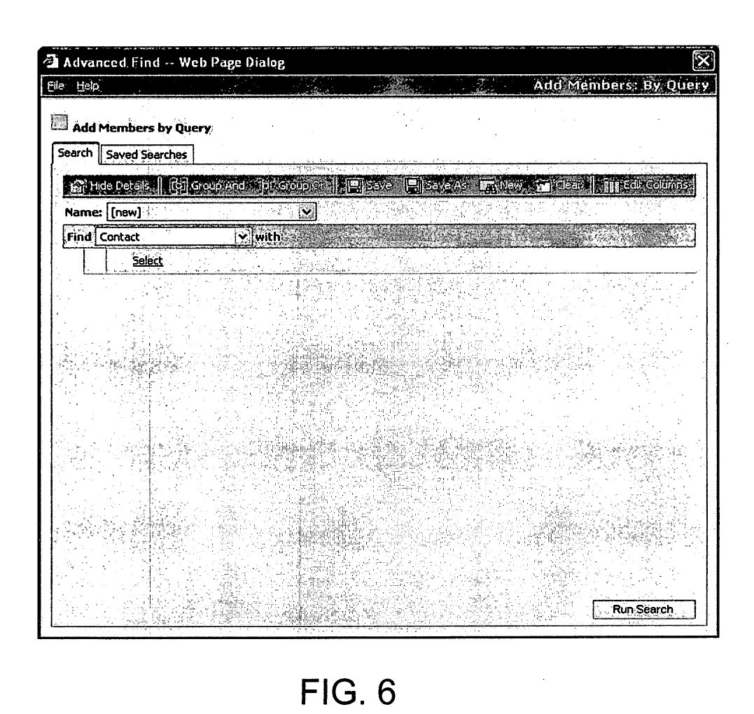

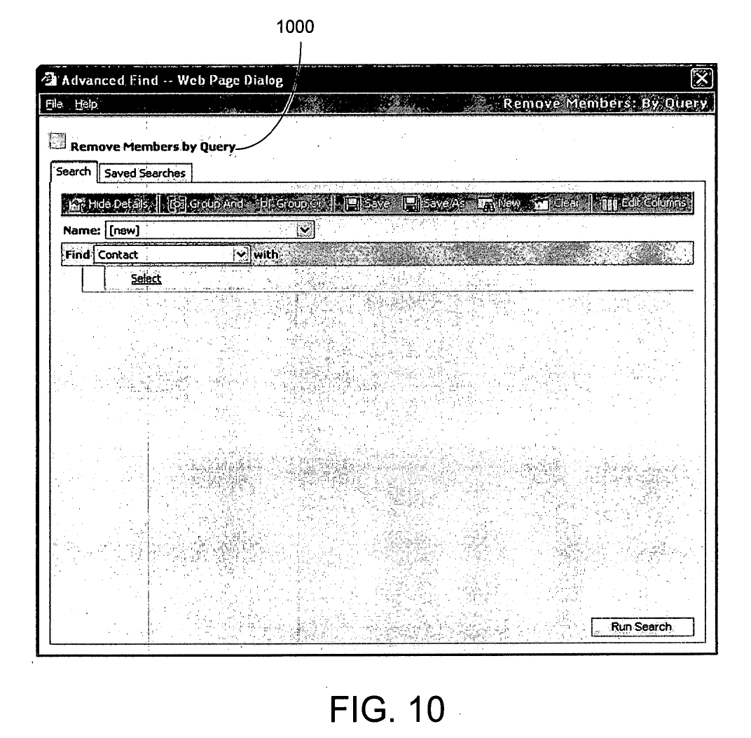

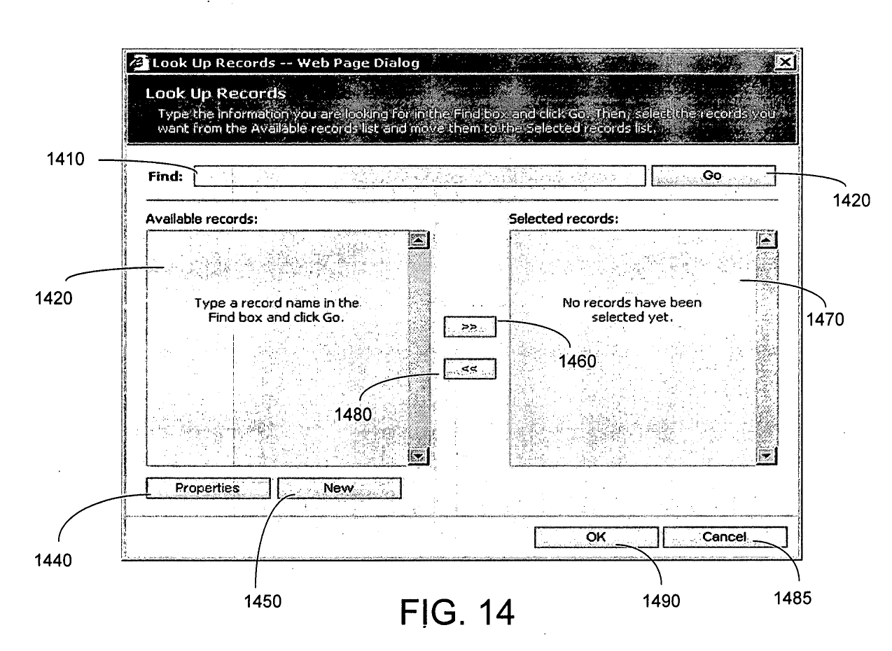

FIG. 4 may be an illustration of a display of the list member view of the list. This view may be generated by selecting the members tab 410. The display may indicate the number of members 415 in the different accounts that are part of the list 420. An action tab 425 may be selected and the options displayed in FIG. 5 may be presented to the user, specifically, displayed members may be added to a list, may be removed from a list and may be used to create a new list. An “Add Members by Query” tab 430 may allow members to be added to a list by using queries and may result in the display illustrated in FIG. 6 and discussed below. A “Remove Member by Query” tab 435 may allow members to be removed from a list by using queries and may result in the display illustrated in FIG. 10 and discussed below. An “Add Members by Lookup” tab 440 may allow members to be added by using a lookup and may result in the display illustrated in FIG. 14 and discussed below. In addition, an alphabet bar 445 may be provided which may allow the quick retrieval of lists that begin with the alpha character selected.

FIG. 5 may be an illustration of the display 500 when the action tab 425 is select in FIG. 4. A drop down box may be present which may allow a highlighted member to be removed from a list by select the “remove from List” 510 option. In addition, a highlighted member of a list may be copied to another list by selecting the “copy to List” option 520. A “Create Opportunity” tab 530 may allow an opportunity to be created for a highlighted member of the list. Members of the list may be highlighted or selected in any manner such as “clicking” on the member with a mouse and multiple members may be highlighted or selected by holding down the “Control” key, for example.

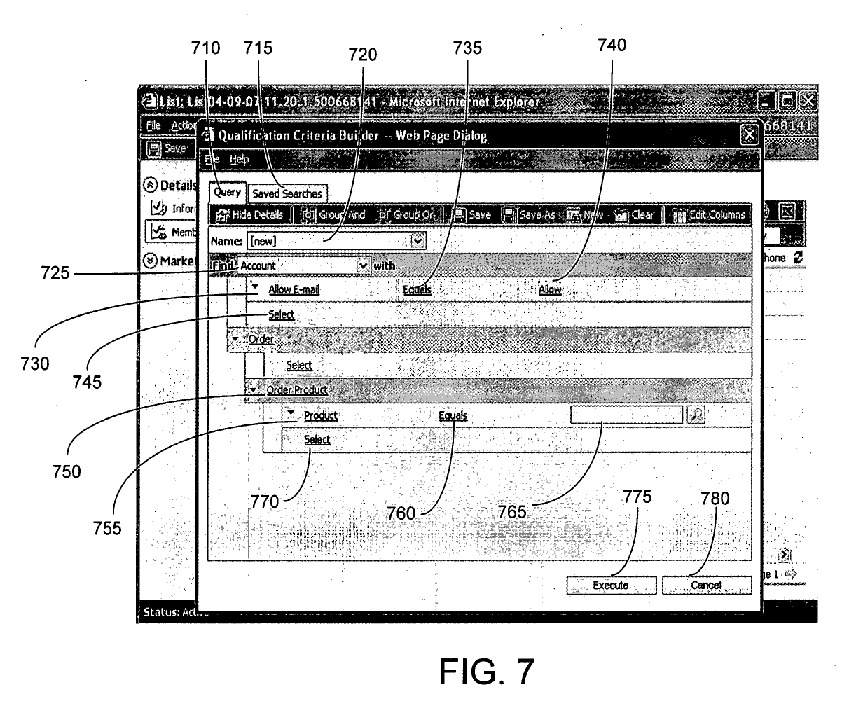

FIG. 6 may be an illustration of a display when the “Add Members by Query” tab 430 of FIG. 4 is selected. FIG. 7 may be an illustration of a possible query to qualify a list. The user may be permitted to create a new query by selecting the query tab 710 or review saved searches by selecting the saved searches tab 715. If the new query tab 710 is selected, the user may be permitted to name the query in the name box 720. From there, a graphic display may be presented to the user to allow the user to “slice and dice” a list to create a list with desired attributes. For example, a user may be permitted to find an account, a lead or a contact by selecting a lead, an account or a contact from the drop-down box 725.

Cascading down the qualification display, selected attributes can be added which the user desires the contact to contain. For example, in the illustrated query, the allowed email field 730 should be indicated as equaling 735 the term “allow” 740, which may indicate that the user is selecting accounts that allow email. The user may be permitted to use the select button 745 to pull contacts from the list that have the “allow email” field 730 equal 735 to “allow” 740. The “equal” qualification may also be modified to search for items that are greater, less than, similar to, sound like, prior to, later than, etc., depending on the selection query in question.

In addition, a user may be permitted to further narrow the query for even more selected attributes. For example, under the order product tab 750, a user may be permitted to select products 755, which would have the indicated attribute of equaling 760 something displayed in a drop-down box 765. The drop-down box 765 may be permitted where a variety of products and services may be displayed and selected by a user. By using the additional select button 770, a more narrow search for attributes may be executed in which 725 may be searched at allow email 730 equals 735 to “allow” 740 and where the product 755 equals 760 a selected field 765. By using the select button 745, a user may be permitted to view a display on the list member view grid, the results of the query and then the user may be permitted to choose to edit, assign, delete, share or add to the list. In addition, once a user is finished selecting contacts to add, the query can be executed by selecting the execute button 775 or the entire query can be canceled by selecting the cancel button 780.

As a further example, a user may select to create a query called “six months” in which all accounts are reviewed to determine if they placed an order within the last six months. The list may be further modified to select only those people who have not placed in order within the last six months and are allowed to received email. A user may then select to view the individual numbers that satisfy such a query and those individual numbers can be further modified to create a more desirable list. Once a user is satisfied with the membership of the list, the list can be saved as a first order object and the list can then be used like any other first order object, meaning it can be searched, it can be emailed, it can be used as a reference, as a variable, etc.

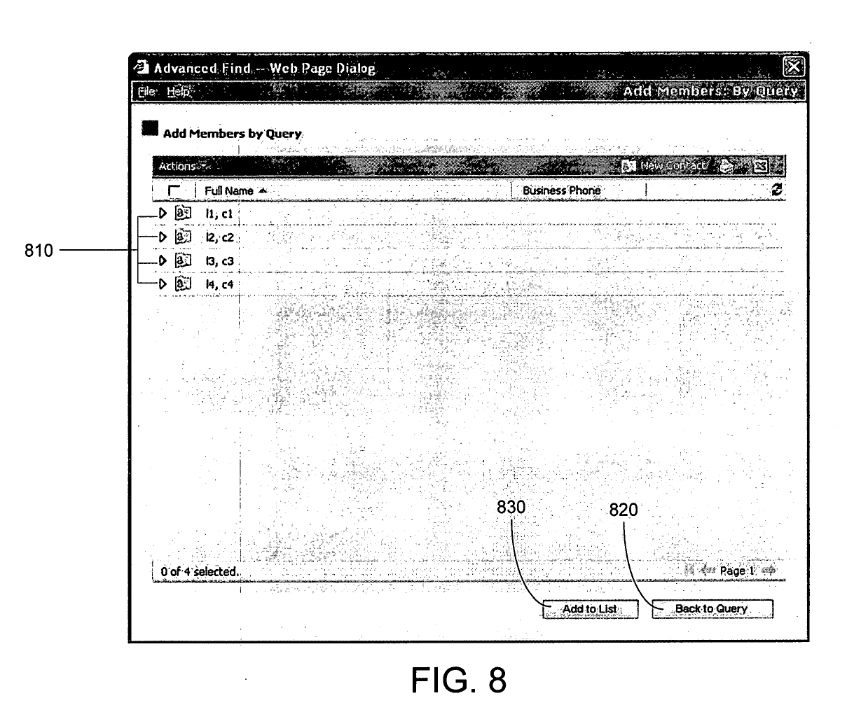

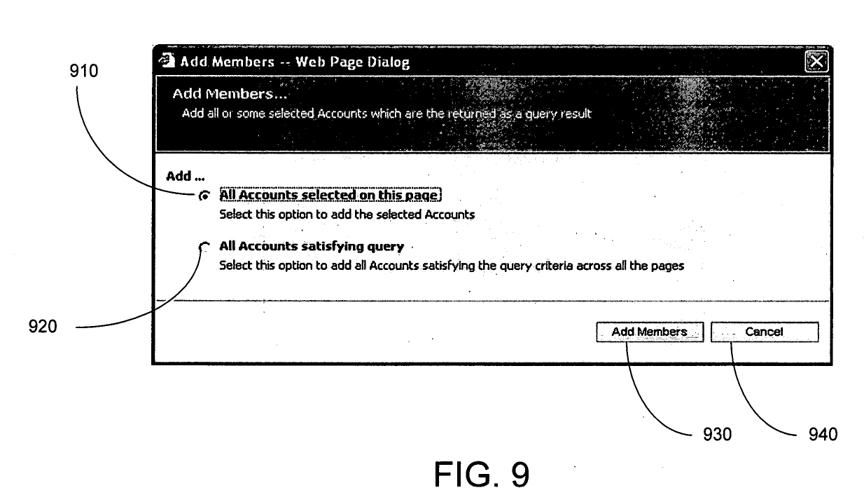

FIG. 8 may be an illustration of the results of the query of FIG. 7. In this example, four members 810 are listed as meeting the query. If none of the members are desired to be added to the list, the “Back to Query” button 820 may be selected and control may pass back to a display such as illustrated in FIG. 4. More information on the displayed members 810 such as sales volume or date of last sale may be obtained by selecting the members and using menu options to view further information on the selected members. Members may be added to the list by selecting the “add to List” tab which may result in a display such as the illustration in FIG. 9. All or some of the members may be selected by clicking on the members. All members selected on the page illustrated in FIG. 8 may be added by selecting a tab 910 and all the members on FIG. 8 (the members that satisfied the query) may be added to the list (whether the were selected or not) by selecting tab 920. Once tab 910 or 920 has been selected, tab 930 adds the members to the list. Tab 940 cancels the proposed addition of members to the list.

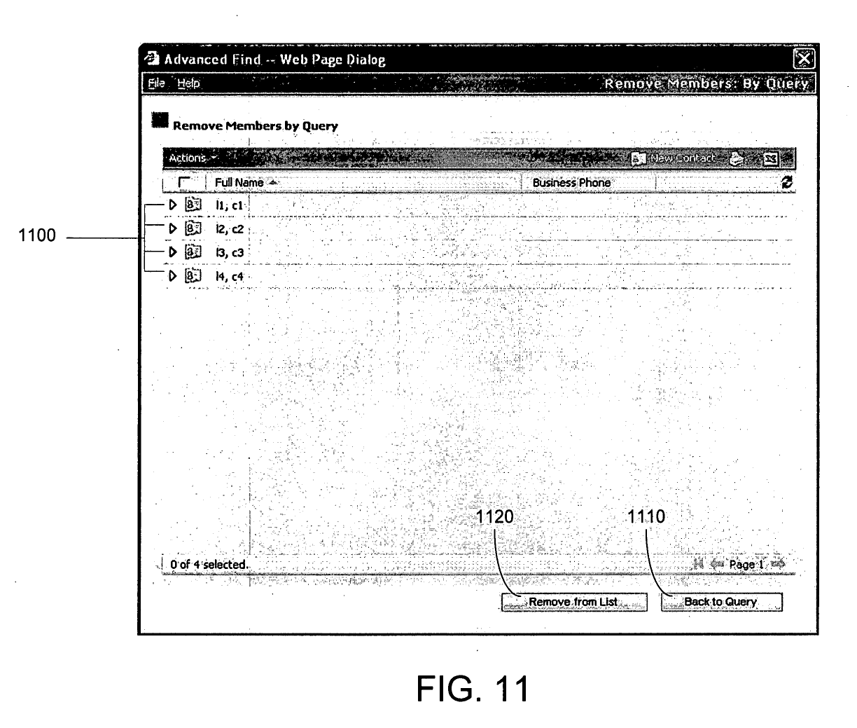

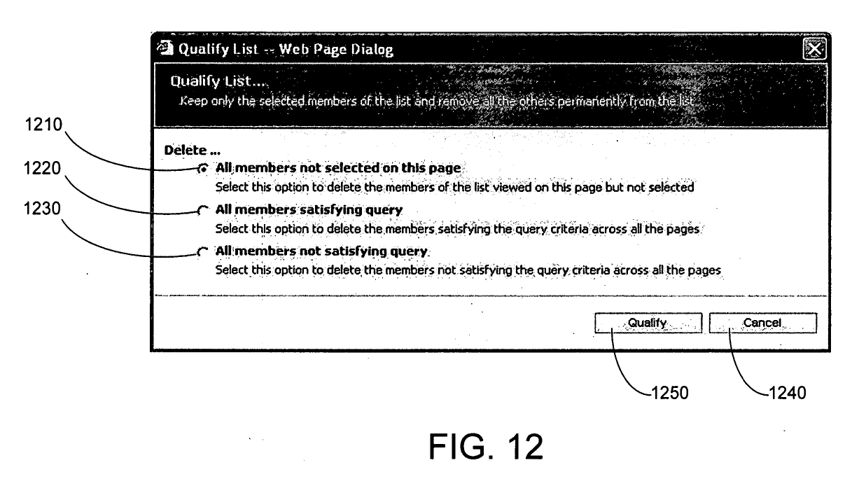

FIG. 10 may be an illustration of a query screen 1000 that may be displayed when the “Remove Members by Query” tab 435 is selected in FIG. 4. The query screen is similar to the query screen for adding members as illustrated in FIGS. 6 and 7. FIG. 11 may be a display of the results of the query of FIG. 10 where the members that meet the query 1100 are displayed. Similar to the display of FIG. 8, a user may select members and view additional information on the members. If none of the displayed members are desired to be removed, tab 1110 may return control to the query screen of FIG. 10. Selecting tab 1120 may result in a display as illustrated in FIG. 12.

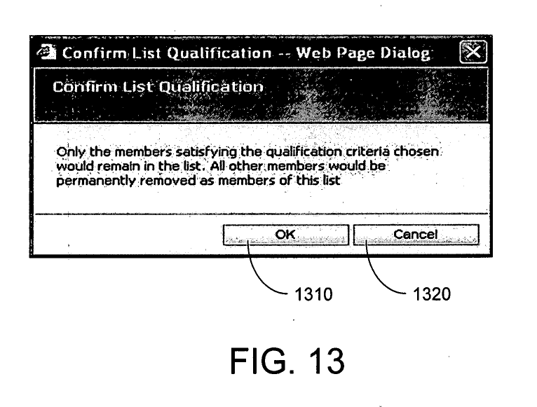

FIG. 12 may be an illustration of a display of the options presented when members have been located that meet a query to be deleted. By selecting tab 1210, all the members that were not selected in FIG. 11 may be deleted from the list. This may be useful when a large number of members has been located and instead of having to highlight all the members to be deleted, only the members desired to be kept may be highlighted. For example, if 250 members resulted from a query and only 3 were desired to be kept, a user may only have to select 3 members rather than 247 members. Selecting tab 1220 may delete from the list all the members identified by the query, whether or not the members have been selected. Selecting tab 1230 may delete all the members of a list that did not meet a query. In this way, the query may be used to locate the desired members and all the undesired members may be deleted. If none of the members are desired to be removed, then tab 1240 may allow the user to cancel out of the qualification of the list. Once one of tab 1210, 1220 and 1230 has been selected, tab 1250 may proceed with the removal of the members from the list and a display such as in FIG. 13 may be displayed. FIG. 13 may allow the confirmation that the action selected in FIG. 12 will be enacted by allow the selecting of an “OK” tab 1310 or a “Cancel” tab 1320, which may cancel the qualification/deletion.

FIG. 14 may be an illustration of a display that occurs when tab 440 is selected in FIG. 4 to look up records to be added to a list. For example, if a certain record has not satisfied a query but personal knowledge dictates that this record should be included, a user may simple look up the desired record and add it to the list. In an input box 1410, a user can type in something desire to be found. Clicking the “Go” tab 1420 may start the look-up. Available records may then be displayed in a first box 1420. Further information about a selected record may be found by selecting the “Properties” button 1430. The available records box 1420 may be cleared by selecting the “New” button 1450. Selected records that are desired to be added to the list can be highlighted and selected by “>>” or add button 1460 and records which have previously been selected and displayed in the selected box 1470 but are no longer desired to be part of the list may be removed by selecting the “<<” or “remove” button 1480. If the record addition is desired to be canceled, the “Cancel” button 1485 may be selected. If the record addition is desired, the “OK” button 1490 may be selected and the selected records displayed in the box 1470 may be added to the list.

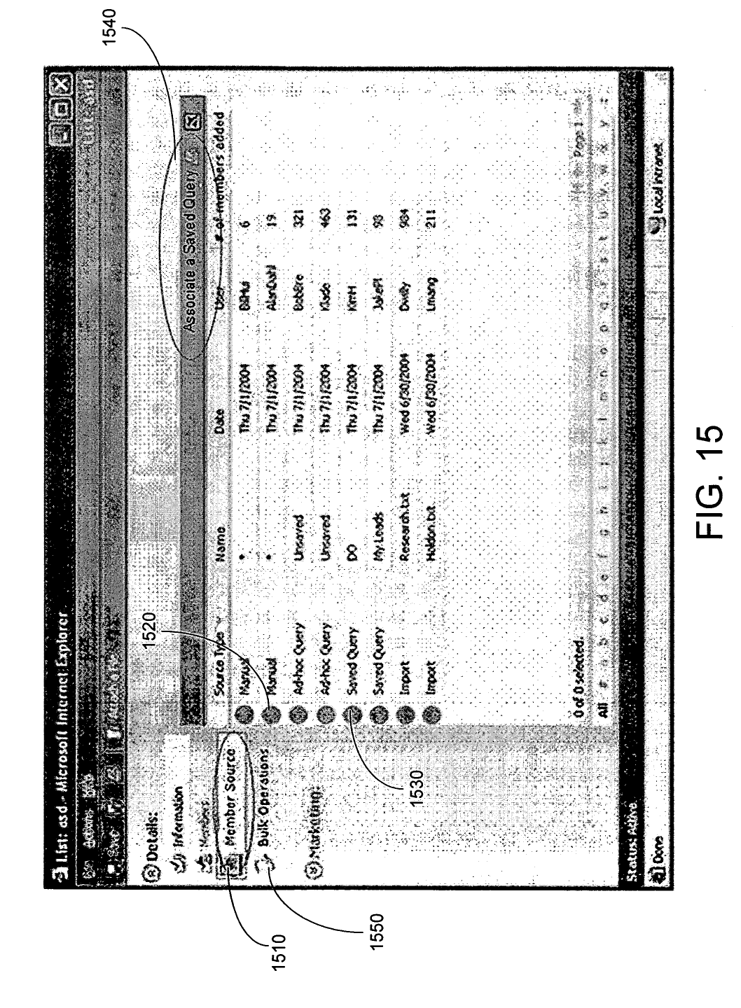

FIG. 15 may be an illustration of additional options that may be presented to a user. Selecting the “Member Source” tab 1510 may display the source of the members of a list. For example, “Source Type” Manual 1520 lists that “User” AlanDahl added 19 members manually on Jul. 1, 2004 and “Source Type” Saved Query 1530 indicates that 131 members were added by using query name “DO” on “Date” Jul. 1, 2004 by “User” KimH. This may be useful to better track performance of List or how successful lists were created or which user contributed the most to creating a list.

Another option in FIG. 15 is to select the tab “Associate a Save Query” 1540. Tab 1540 may allow a query to be associated with a list. This may be advantageous in repopulating the list in the future. For example, by associating a saved query such as “high sales” with an existing list, new customers with high sales may be added using the “high sales” query and opening the list. By having the “high sales” query associated with the list, new member that meet the “high sales” query may be included in the list.

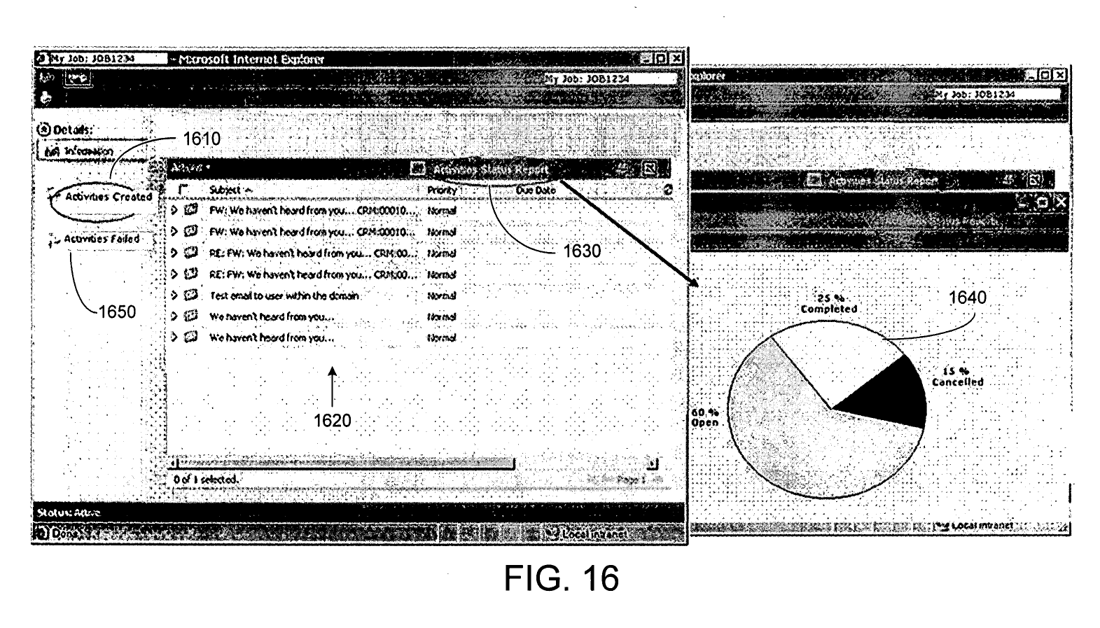

The tab “Bulk Operations” 1550 may result in a display as illustrated in FIG. 16. The illustration may indicate the status of bulk operations that were performed on a list. An “Activities Created” tab 1610 may result in a display of activities 1620 created for a list. By selecting an “activities Status Report” 1630, further detail may be graphically illustrated 1640 that may indicate how much of the assigned activities has been completed. A user may also may be able to select an “Activities Failed” tab 1650 that may indicate which activities associated with a list have not successfully completed.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A method of creating a list for marketing comprising of:
reviewing a source of entries wherein the source is stored electronically;
selecting a subset of entries from the source of entries; and
storing the subset of entries as a list wherein the list comprises a first order object.

2. The method of claim 1, further comprising allowing a user to re-use a list.

3. The method of claim 1, further comprising importing additional details about the entries from an internal source if the source is an internal source.

4. The method of claim 1, further comprising qualifying the list by selecting entries from the source that have a desired attribute.

5. The method of claim 1, further comprising allowing the list to be modified and saved as a second list.

6. The method of claim 1, further comprising creating a second list that is a result of a query on a first list.

7. The method of claim 1, further comprising creating a third list by merging a first list with a second list.

8. A computer readable medium having computer executable instructions for performing a method of creating a list for marketing comprising:
computer executable instructions for reviewing a source of entries wherein the source is stored electronically;
computer executable instructions for selecting a subset of entries from the source of entries; and
computer executable instructions for storing the subset of entries as a list wherein the list comprises a first order object.

9. The computer readable medium of claim 8, further comprising computer executable instructions for allowing a user to re-use a list.

10. The computer readable medium of claim 8, further comprising computer executable instructions for importing additional details about the entries from an internal source if the source is an internal source.

11. The computer readable medium of claim 8, further comprising computer executable instructions for qualifying the list by selecting entries from the source that have a desired attribute.

12. The computer readable medium of claim 8, further comprising computer executable instructions for allowing the list to be modified and saved as a second list.

13. The computer readable medium of claim 8, further comprising computer executable instructions for creating a second list that is a result of a query on a first list.

14. The computer readable medium of claim 8, further comprising computer executable instructions for creating a third list by merging a first list with a second list.

15. A computing apparatus, comprising:
a display unit that is capable of generating video images;
an input device;
a processing apparatus operatively coupled to said display unit and said input device,
said processing apparatus comprising a processor and a memory operatively coupled to said processor,
a network interface connected to a network and to the processing apparatus;
said processing apparatus being programmed to review a source of entries wherein the source is stored electronically;
said processing apparatus being programmed to select a subset of entries from the source of entries; and
said processing apparatus being programmed to store the subset of entries as a list wherein the list comprises a first order object.

16. The computing apparatus of claim 15, further comprising said processing apparatus being programmed to allow a user to re-use a list.

17. The computing apparatus of claim 15, further comprising said processing apparatus being programmed to import additional details about the entries from an internal source if the source is an internal source.

18. The computing apparatus of claim 15, further comprising said processing apparatus being programmed to qualify the list by selecting entries from the source that have a desired attribute.

19. The computing apparatus of claim 15, further comprising said processing apparatus being programmed to allow the list to be modified and saved as a second list.

20. The computing apparatus of claim 15, further comprising said processing apparatus being programmed to create a second list that is a result of a query on a first list.
